(19) United States
(12) Patent Application Publication
(10) Pub. No.: US 2005/0086519 A1
(43) Pub. Date: Apr. 21, 2005

(54) Routing method and routing system with conditional logging

(76) Inventors: Herbert Meier, Geretsried (DE); Michael Tinnacher, Koflach (AT)

Correspondence Address: Siemens Corporation;Intellectual Property Department, 170 Wood Avenue South, Iselin, NJ, 08830, US

(21) Appl. No.: 10/503,758

(22) PCT Filed: Sep. 12, 2002
(86) PCT No.: PCT/EP02/10255

(30) Foreign Application Priority Data
Feb. 4, 2002 (EP) 02002561.5

(51) Int. Cl. H04L 9/00

(52) U.S. Cl. 713/201

(57) ABSTRACT

The invention relates to a routing method and a routing system for messages in a network, according to which a forwarding mechanism is coupled to a logging mechanism in such a way that a message is written into a log file of the logging mechanism only if a target entity cannot be reached for said message.

### CROSS REFERENCE TO RELATED APPLICATIONS

This application is the US National Stage of International Application No. PCT/EP02/10255, filed Sep. 12, 2002 and claims the benefit thereof. The International Application claims the benefits of European application No. 02002561.5 filed Feb. 4, 2002, both of the applications are incorporated by reference herein in their entirety.

### FIELD OF INVENTION

The invention relates to a routing method and routing system for messages in a communication network which are to be forwarded from a transmitting entity to at least one target entity and in which the method refers to a logging mechanism which serves to store temporarily the messages in at least one log file and/or refers to a forwarding mechanism which provides network-applicable addressing of at least one target entity and routes at least one message to a target entity.

The invention particularly refers to the occasional and thereby conditional access to the logging mechanism.

### BACKGROUND OF INVENTION

Systems and methods for routing messages in a communication network such as in a telecommunications network of the type mentioned at the start of this document serve to monitor and control the network. One of the elements involved in monitoring and controlling a network for telecommunications applications is the use of the TMN (telecommunications management network) concept, which in its turn is based on the OSI reference model. The latter is an abstract description of communication between open systems which introduces a hierarchy of layers which are independent from one another in each case. Besides means for transporting and processing information, the TMN also provides means for managing networks and services. Thus, the routing of specific messages is of particular interest, such as the synchronization of events or data which refers to measurements, alarm and warning messages or messages which refer to resolving a critical state.

When the networks just described are managed it is necessary to route specific messages or events through the network, i.e. to route them from a transmitting entity to a target entity. These messages mainly relate to monitoring and/or managing the network.

Within the TMN network concept there are now two basic mechanisms for routing messages or network events: One hand is known as the forwarding mechanism and the other as the logging mechanism. However, the functions of the two mechanisms have thus far been entirely separate.

The forwarding mechanism serves to make OSI applications addressable on different systems so that they can receive specific messages. If a primary address cannot be reached then a second address can be specified as an aid, which then becomes the target entity if the primary address cannot be reached. In the case of errors, this mechanism—applied alone—leads to the message being lost in any event. This is why the logging mechanism is also used.

The logging mechanism includes the creation of so-called log files in which the messages are at least stored temporarily. The log files are located locally on the system which has output the specific message. However, in this case there is no provision for the messages of the log file to be forwarded to the applications.

Because, as has already been mentioned above, both mechanisms in the case of the previous method in the prior art were already functionally separated from one another, it was not possible until now to use information or data which was obtained during processing of the one mechanism in the other mechanism. This results in considerable losses which have an adverse effect on the performance in particular.

In order to ensure, for example, that management-related messages to be sent are not lost if there is a network problem or the target entity or the receiver of the message is not available, all the messages are always logged in parallel for previous systems according to the prior art. However, in all cases in which messages can be forwarded to the target entity, parallel logging is actually superfluous. Such a—partly redundant—procedure requires more resources and, therefore, has the disadvantage that additional memory space and additional CPU time must be made available.

Within this context, WO 99/31892 typically discloses a system for forwarding and logging digital messages in a telecommunications network. This system also uses log files for incoming messages which are then processed further. However, an essential difference to the system according to the invention is that each message which is sent to a management system is also logged in parallel. Therefore, the logging mechanism is also active in all cases and, therefore, disadvantageously also in cases in which a logging is not required.

The availability of these messages on the one side and the throughput or performance of the management system on the other side are, therefore, in a reciprocal relationship and are the critical variables.

### SUMMARY OF INVENTION

Therefore, it is the object of the invention to demonstrate a way in which it can be assured that messages which cannot be forwarded to the target entity (for example, as a result of a network error) are not lost without this resulting in the performance of the management system being reduced.

The object of the invention is achieved in particular by a routing method of the type mentioned at the start in which the logging mechanism is only accessed in particular cases, preferably if routing of the message to at least one of the corresponding target entities is not possible and/or if the forwarding mechanism could not be executed successfully while the logging mechanism is expanded in such a way and coupled to a forwarding mechanism which optionally allocates a network-applicable address to the log file of the logging mechanism, said address being addressable within the forwarding mechanism.

A solution problem addressed by the invention according to a product claim comprises a routing system for messages in a communication network which are to be forwarded from a transmitting entity to at least one target entity, with:
a logging unit which serves to buffer the messages in at least one log file,
a forwarding unit which provides network-applicable addressing of at least one target entity and which routes at least one message to a target entity,
   in which
   the logging unit is then only used in particular cases and preferably if the forwarding unit is not operating successfully and/or if the message cannot be forwarded to at least one of the corresponding target entities while the logging unit is expanded in such a way and coupled to a forwarding mechanism which optionally allocates a network-applicable address to the log file of the logging mechanism, said address being addressable within the forwarding mechanism.

One example of a routing method according to the invention relates to the TMN network according to the ITU recommendations of the X.73x series in which a forwarding mechanism (event forwarding) and a modified logging mechanism (log control function) have been coupled.

The logging mechanism is expanded by OSI addresses (Open Systems Interconnection, OSI) being allocated to the log files of the logging mechanism which can simultaneously be addressed by the forwarding mechanism and processed by it. Therefore, it is only possible to refer to the logging mechanism in those cases where it is not possible to route a message to the target entity (perhaps, because the forwarding mechanism could not be executed successfully as a result of a general network error). Thus, the invention provides case-specific, conditional automatic logging which markedly improves the performance of the management system.

The allocation according to the invention of an OSI address to a log file makes it possible for the event forwarding function to send messages to a local log system if the remote applications cannot be reached. This is, for example, the case for a general network error.

An important advantage is more safety for critical events and easier management of the system because the local log contents and events can be linked via the same management as is the case for the allocation to remote applications.

According to the invention, critical events are subject to logging only if the remote application cannot be reached. This leads to a distinct reduction in the required computer capacity and the required memory space. Altogether, the required resources can clearly be reduced in an advantageous way.

In addition this makes synchronization between the remote application and the network element easier because a reconciliation between the logged messages (i.e. those stored in the log file) and messages received from the target entity is no longer needed, as the procedure according to the invention ensures that the logged events have not been received by the target application.

An additional advantage is to make available automatic logging without increasing the load with regard to resources required.

Alternative embodiments of the invention provide for the messages to be written into a number of log files. This is of particular interest in those cases where different applications must at least partially refer back to the same messages. However, these systems can then actively collect the relevant messages in each case.

In a preferred embodiment of the invention, the log file is located locally on the system which outputs the specific message. This has the advantage that even a network error does not have an adverse effect when the message is logged. Therefore, this ensures that even in the case of an incorrect transmission link—for example, on the basis of a network failure—the relevant events can be identified and are not lost.

The embodiments of the method according to the invention described above can also take the form of a computer program product, with a computer-readable medium and with a computer program code means and in which the computer is activated after the computer program has been loaded to execute the inventive method described above.

An alternative method of achieving the object of the invention is provided by a storage medium that stores the described, computer-implemented method and can be read by using a computer.

Additional, advantageous embodiments are produced by the dependent claims.

### BRIEF DESCRIPTION OF THE DRAWINGS

Further features and advantages of the invention will emerge from the description which follows of the embodiments and from the accompanying drawings. These drawings show:

FIG. 1 an overview of the routing method according to the invention,

FIG. 2 important processes when processing messages according to the invention.

### DETAILED DESCRIPTION OF INVENTION

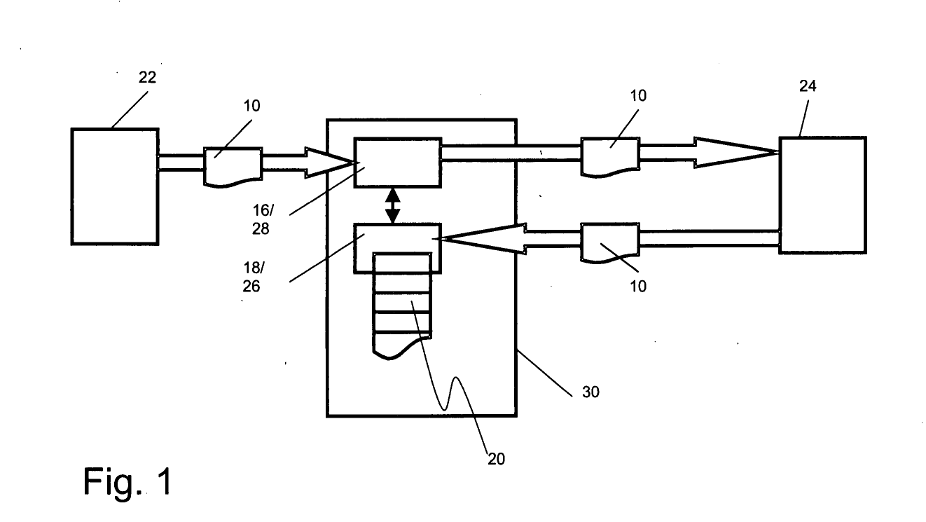

As shown in FIG. 1, the invention concerns the routing of messages 10 in a communication network 12. Therefore, the messages 10 are exchanged between different applications 14 which can sometimes be found on different systems.

In essence, the messages 10 relate to monitoring and managing the network 12 so that it must be ensured that the messages 10 are also not lost in the case of errors, but are stored temporarily so that they can be called up again later.

In the preferred embodiment of the invention, the network 12 is a TMN network according to the ITU X.700 series Recommendations. Here, two previous mechanisms are provided for routing the messages 10:
1. a forwarding mechanism 16, so-called event forwarding (according to X.733) and
2. a logging mechanism 18, the so-called log control function (according to X.734).

The forwarding mechanism 16 fulfills the task of routing events in the network 12 to other systems.

The function of the logging mechanism 18 is to log events in the network element, this means to write a log file 20 into a storage unit or a temporary storage and thus to ensure that it is not lost. The events can then be fetched actively from other systems at a later point in time.

According to the invention, both modules are coupled functionally to each other so that data or events of the one method are made available or can be processed by using the other method and a reciprocal calling of functions becomes possible.

This is achieved by expanding the logging mechanism 18. The expansion refers to the allocation of an OSI address to the log file 20.

The forwarding mechanism 16 is designed in such a way that as the main or secondary objective not the usual application, but a log control function or a specific log file 20 is given. The log file 20 can now be addressed and processed within the forwarding mechanism 16. This allows the following procedure:

If a message 10 is to be sent from a transmitting entity 22 to a target entity or target application 24 which cannot be reached at present, for example, on the basis of a network error, then the forwarding mechanism 16 encounters an error because the current address of this target application 24 is invalid.

In order to now prevent the message 10 from being deleted, the OSI address of the log file 20 is specified within the forwarding mechanism 16 in this case. The result of this is that the message 10 is now sent to the address of the log file 20 or logged in the log file 20 and stored temporarily.

In the case of very high volumes of messages within the network 12 it is apparent that general logging all messages 10 (as occurs in the prior art) entails an insupportable load on resources.

Therefore, according to the invention, messages 10 are logged automatically on the one hand and only conditionally on the other hand, i.e. under certain conditions: the logging mechanism 18 is only activated automatically according to the invention if the forwarding mechanism 16 could not route the message 10 to the intended target application 24.

Because of processing according to the invention and because of the network topology it is ensured that a logged message 10 was not received from the specific target application 24. As a result, redundancies can be securely excluded.

If the specified primary or alternate target application 24 cannot be reached, the message 10 is entered in the log file 20. The target application 24 can then actively fetch the corresponding message 10 itself. This is undertaken either cyclically, periodically or basically after a network error such as, for example, after a network has failed.

The separate Q3 object models of the forwarding mechanism 16 and the logging mechanism 18 are coupled to each other while an OSI application address is allocated optionally to a Q3 log entity.

The invention also refers to a routing system for the messages 10 in the network 12. The routing system includes a logging unit 26, a forwarding unit 28 and, in the preferred embodiment, an administration unit 30 which controls and/or manages the logging unit 26 and the forwarding unit 28.

One of the tasks of the administration unit is to define the periods within which the logging mechanism 18 is to be activated or whether or not it should be active continuously.

In addition, the administration unit 30 includes the processes which control the exchange of messages 10 between the logging mechanism 18 or the forwarding mechanism 16, on the one hand, and the target application 24, on the other hand. These processes are, for example, the conditions for reading out the messages 10 from the log file 20. Here, an access authorization of the target application 24 can, for example, check or monitor whether or not the target application can directly access the log file 20 or access it indirectly via the forwarding mechanism 16.

The administration unit 30 also includes a discriminator unit which distinguishes between the following cases:
‘Message 10 can be forwarded successfully to the target application 24’ and
‘message 10 cannot be forwarded successfully to the target application 24’.

According to the invention, on the basis of expanding the forwarding and the logging model and linking both models, which has a synergistic effect, a further particular advantage lies in the fact that events cannot just be sent to applications, but also to other procedures (to the log control function).

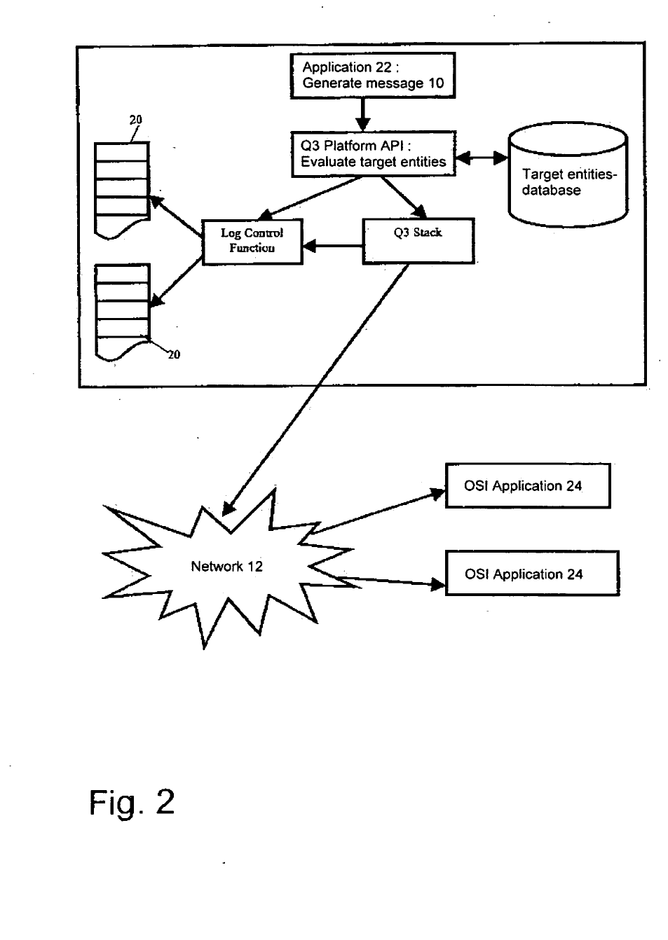

With reference to FIG. 2, the inventive sequence of the method is now explained as follows:

In the preferred embodiment, as soon as the application outputs a message 10, the target entity for this message 10 is evaluated by accessing the internal database. This database already contains the entries of both the logging target entities and the OSI applications.

This evaluation then results in two tables: a log table which indicates where the message 10 is to be logged and an OSI application table which provides the data via the primary and the alternative target entities of the OSI applications of the forwarding mechanism 16.

If the log table has at least one entry, the message 10 is forwarded together with the log table and activates the writing of the message 10 into all evaluated logs.

If the OSI application table has an entry then the message 10 is forwarded together with this table to the Q3 stack which as a result tries to send the message 10 to the addresses which have been specified as the primary address. If this attempt is still not successful the message 10 is sent to the alternate addresses or target entities. This is where the most important advantage of the invention comes into play because, within the OSI table, logs can now also be determined as entries which can thus be reached via the internal log control function.

1.-15. (canceled)

16. A routing method for messages in a communication network, comprising:
providing a transmitting entity;
providing at least one target entity;
providing a forwarding mechanism for network-applicable addressing of at least one of the target entities;
providing a logging mechanism for buffering messages in at least one log file; and
forwarding the messages from the transmitting entity by the forwarding mechanism to its target entity or buffering the messages by the logging mechanism whenever the messages cannot be forwarded to at least one of the target entities of the forwarding mechanism.

17. The method according to claim 16, wherein the transmitting entity and the target entity belong to different and/or independent systems.

18. The method according to claim 16, wherein the log file is locally connected to the transmitting entity or via a safe network topology.

19. The method according to claim 17, wherein the log file is locally connected to the transmitting entity or via a safe network topology.

20. The method according to claim 16, further comprising:
optionally allocating a network-applicable address to the log file for coupling the logging mechanism to the forwarding mechanism, said address being addressable within the forwarding mechanism.

21. The method according to claim 17, further comprising:
optionally allocating a network-applicable address to the log file for coupling the logging mechanism to the forwarding mechanism, said address being addressable within the forwarding mechanism.

22. The method according to claim 18, further comprising:
optionally allocating a network-applicable address to the log file for coupling the logging mechanism to the forwarding mechanism, said address being addressable within the forwarding mechanism.

23. The method according to claim 20, wherein
the transmitting entity and the target entity are OSI applications and wherein
the network-applicable address that is allocated to the log file is an OSI address.

24. The method according to claim 20, wherein the network-applicable address is allocated to the log file via the same management routines as the allocation to remote applications.

25. The method according to claim 20, wherein the network-applicable address is allocated to the log file in the same way as the allocation to remote applications.

26. The method according to claim 23, wherein the network-applicable address is allocated to the log file via the same management routines as the allocation to remote applications.

27. The method according to claim 16, wherein the method is performed by a computer program.

28. The method according to claim 27, wherein the computer program is implemented on a computer readable medium.

29. A product for routing messages in a communication network, comprising:
a logging unit for buffering the messages in a log file; and
a forwarding unit for network-applicable addressing of a target entity and for forwarding the messages from a transmitting entity to its target entity, wherein
the messages are forwarded from the transmitting entity by the forwarding unit to its target entity or
the messages are buffered by the logging mechanism whenever the messages cannot be forwarded to a target entity of the forwarding unit.

30. The product according to claim 29, wherein the log file of the logging unit is located locally in relation to the transmitting entity.

31. The product according to claim 29, further comprising an administration unit that manages the logging unit and/or the forwarding unit.
